(19) United States
(12) Patent Application Publication
(10) Pub. No.: US 2025/0187194 A1
(43) Pub. Date: Jun. 12, 2025

(54) AUTOMATED GAS SUPPLY SYSTEM INCLUDING MOBILE ROBOT

(71) Applicant: KC CO., LTD., Gyeonggi-do (KR)

(72) Inventors: Sang Jin KIM, Gyeonggi-do (KR); Nam Eung KIM, Gyeonggi-do (KR); Yong Geon PARK, Gyeonggi-do (KR); Young Hoon KIM, Gyeonggi-do (KR); Jung Hoon LEE, Gyeonggi-do (KR); Du Seok LEE, Gyeonggi-do (KR); Jong Chan KIM, Gyeonggi-do (KR)

(73) Assignee: KC CO., LTD., Gyeonggi-do (KR)

(21) Appl. No.: 18/970,785

(22) Filed: Dec. 5, 2024

(30) Foreign Application Priority Data
Dec. 8, 2023 (KR) 10-2023-0177861
Feb. 13, 2024 (KR) 10-2024-0020629

(51) Int. Cl. B25J 9/16; B25J 15/00; G05D 1/689

(52) U.S. Cl. CPC B25J 9/1679; B25J 9/1697; B25J 15/0019; G05D 1/6895

(57) ABSTRACT

A gas supply system includes a cabinet in which a gas container is disposed, a fastening device movable with respect to the gas container, and fastenable to a valve of the gas container while aligned with the valve, a mobile robot device detachably connected to the fastening device and configured to move the fastening device, a three-dimensional (3D) vision camera configured to collect an image, and a processor configured to control an operation of the mobile robot device based on the image collected by the 3D vision camera.

### CROSS-REFERENCE TO RELATED APPLICATION

This application claims the benefit of Korean Patent Application No. 10-2023-0177861 filed on Dec. 8, 2023, and Korean Patent Application No. 10-2024-0020629 filed on Feb. 13, 2024, in the Korean Intellectual Property Office, the entire disclosures of which are incorporated herein by reference for all purposes.

### BACKGROUND

### 1. Field of the Invention

The following embodiments relate to an automated gas supply system including a mobile robot.

### 2. Description of the Related Art

In general, for a process that uses gas, for example, a process in which precise tasks are performed, such as a semiconductor manufacturing process, it is required to supply an appropriate type of gas for each process while satisfying a predetermined concentration and pressure.

For efficient gas supply during the process, various types of gases are stored in gas containers under high pressure, and gas containers holding gases with substances harmful to the human body are stored unmanned under strict management.

A gas container is connected to a gas supply device to discharge the gas stored therein, and when the gas in the gas container is completely exhausted, a series of replacement operations of disconnecting the gas supply device from a valve of the gas container, removing the gas container, and connecting a new gas container to the gas supply device are performed.

Meanwhile, to connect the gas supply device to the gas container, the valve of the gas container and the gas supply device need to be aligned. However, since it is difficult to align the gas container at the desired position due to its great weight, the gas supply device is aligned with respect to the valve of the gas container. The gas supply device includes an actuator for adjusting its position and receiving power for operation, and thus, it is required to form a cabinet, where the gas supply is performed, in a size to accommodate the gas supply device.

The above description is information the inventor(s) acquired during the course of conceiving the present disclosure, or already possessed at the time, and is not necessarily art publicly known before the present application was filed.

### SUMMARY

An embodiment is intended to provide an automated gas supply device miniaturized by positioning a power source outside.

An embodiment is intended to provide an automated gas supply device that may be aligned with respect to a gas container through three-dimensional (3D) mapping through a mobile robot.

According to an aspect, there is provided a gas supply system including a cabinet in which a gas container is disposed, a fastening device movable with respect to the gas container and fastenable to a valve of the gas container while aligned with the valve, a mobile robot device detachably connected to the fastening device and configured to move the fastening device, a three-dimensional (3D) vision camera configured to collect an image, and a processor configured to control an operation of the mobile robot device based on the image collected by the 3D vision camera.

The mobile robot device may include a body movable outside the cabinet; and a robot arm installed on an upper portion of the body, the robot arm including a multi-joint arm. The processor may be configured to generate a 3D model for a valve area of the gas container in real time through the 3D vision camera, match the generated 3D model with any one reference image stored in a database, determine a position and angle state of the valve of the gas container based on the matched reference image, and operate the mobile robot device to align the fastening device in a state to be fastenable with respect to the valve based on a result of the determining.

The processor may be configured to generate a 3D model including a shape of the valve of the gas container or a shape of an end cap mounted on the valve, during a process of generating the 3D model for the valve area of the gas container.

The processor may be configured to determine image similarities by comparing the generated 3D model with a plurality of reference images stored in the database, select a reference image with a highest image similarity to the generated 3D model, and match the selected reference image with the 3D model.

The processor may be configured to generate alignment information about 3D coordinates and an angle for the fastening device to be aligned in a state to be fastenable to the valve of the gas container, based on rotation angle and position information of the 3D model corresponding to the selected reference image.

The processor may be configured to generate the alignment information only when a rotation angle of the 3D model corresponding to the selected reference image is within a set angle range.

The processor may be configured to generate the alignment information only when the image similarity between the selected reference image and the generated 3D model is greater than or equal to a set reference value.

The processor may be configured to control a capturing angle of the 3D vision camera with respect to the valve area of the gas container to be adjusted when the image similarity between the selected reference image and the generated 3D model is less than the set reference value.

The processor may be configured to generate a movement path for aligning the fastening device optimally with respect to the gas container based on the generated alignment information, and control an operation of the mobile robot device so that a position of the fastening device is adjusted according to the generated movement path.

The processor may be configured to, during a process of determining the image similarity between the generated 3D model and the reference image, obtain pixels by dividing the generated 3D model two-dimensionally, and generate a pixel of a 3D image of a geometric structure by combining the obtained pixels, and divide the generated 3D model and the reference image into a plurality of pixel areas, individually match the pixel areas, and determine the image similarity based on a matching state for each of the divided pixel areas.

The gas supply system may further include a clamping device configured to support an outer circumferential surface of the gas container, and rotate the gas container about a rotation axis perpendicular to a ground. The processor may be configured to rotate the gas container about the rotation axis through the clamping device, acquire an image of an end cap mounted on the valve of the gas container for each rotation angle of the gas container through the 3D vision camera when the gas container rotates about the rotation axis, and stop rotating the gas container in a state in which the acquired image of the end cap has an image similarity greater than or equal to a set reference value to a reference image of the end cap stored in the database.

The fastening device may be capable of detaching an end cap mounted on the valve while aligned in a first position with respect to the gas container, and fastenable to the valve while aligned in a second position with respect to the gas container.

The fastening device may include a docking portion, and the mobile robot device may further include a docking module disposed at an end portion of the robot arm to be fastened to the docking portion.

The docking module may include a power motor configured to supply power to the docking portion.

The 3D vision camera may be disposed at an end portion of the robot arm.

The gas supply system may further include a connecting module configured to movably connect the fastening device to the cabinet. The connecting module may include one or more connecting joints configured to connect the cabinet and the fastening device, and each connecting assembly may be length-adjustable and rotatable through a joint.

According to an aspect, there is provided a gas supply system including a cabinet in which a gas container is disposed, a fastening device movable with respect to the gas container and capable of detaching an end cap from a valve of the gas container or fastenable to the valve while aligned with the valve, a mobile robot device detachably connected to the fastening device and configured to move the fastening device, a 3D vision camera configured to collect an image, and a processor configured to control an operation of the mobile robot device based on the image collected by the 3D vision camera. The mobile robot device may include a body movable outside the cabinet, and a robot arm installed on an upper portion of the body, the robot arm including a multi-joint arm. The processor may be configured to generate a 3D model for the end cap mounted on the valve of the gas container through the 3D vision camera, match the generated 3D model of the end cap with any one reference image stored in a database, determine a position and angle state of the end cap mounted on the valve of the gas container based on the matched reference image, and operate the mobile robot device to align the fastening device in a state to be capable of detaching the end cap from the valve based on a result of the determining.

The processor may be configured to determine image similarities by comparing the generated 3D model of the end cap with a plurality of reference images stored in the database, select a reference image with a highest image similarity to the generated 3D model of the end cap, match the selected reference image with the generated 3D model of the end cap, and generate information about movement coordinates and a rotation angle for alignment of the fastening device based on rotation angle and position information of the 3D model corresponding to the matched reference image.

The fastening device may include an end cap detacher configured to detach an end cap mounted on the valve while aligned in a first position with respect to the gas container, a valve connector configured to be fastened to the valve to receive a gas while aligned in a second position with respect to the gas container, and a docking portion configured to receive power from an outside.

The mobile robot device may further include a docking module installed at an end portion of the robot arm, and connected to the docking portion to operate the fastening device, and the docking module may include a fastening portion to be fastened to the docking portion of the fastening device, and a power motor configured to supply power to the fastening device through the docking portion.

According to an aspect, there is provided a gas supply system including a clamping device configured to support a gas container, and rotate the gas container about a rotation axis perpendicular to a ground, a 3D vision camera configured to collect an image, and a processor configured to control an operation of the clamping device. The processor may be configured to operate to rotate the gas container about the rotation axis through the clamping device, collect an image of an end cap mounted on a valve of the gas container for each rotation angle of the gas container at a set point through the 3D vision camera, and select an end cap image having a highest similarity by comparing the end cap images for each rotation angle of the gas container with a reference image stored in a database, and control the clamping device so that the rotation angle of the gas container about the rotation axis is aligned with a rotation angle corresponding to the selected end cap image.

Additional aspects of embodiments will be set forth in part in the description which follows and, in part, will be apparent from the description, or may be learned by practice of the disclosure.

According to an embodiment, a gas supply system may reduce or minimize the space in which a gas supply device is installed by providing power to the gas supply device through a mobile robot that is optionally connected to the gas supply device.

According to an embodiment, a gas supply system may simplify the structure of a gas supply device by detecting the alignment state of the gas supply device with respect to a gas container through a mobile robot positioned outside a cabinet where the gas container is safely placed.

According to an embodiment, a gas supply system may detect the alignment state of a gas supply device with respect to a gas container through 3D mapping using a 3D camera, thereby preventing mounting in a misaligned state to minimize or reduce damage and breakage of the device.

The effects of the gas supply system according to embodiments are not limited to the above-mentioned effects, and other unmentioned effects may be clearly understood from the following description by one of ordinary skill in the art.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a perspective view of a portion of a gas container according to an embodiment;

FIG. 2 is a perspective view of a gas supply system according to an embodiment;

FIG. 3 is a perspective view of a clamping device according to an embodiment;

FIG. 4 is a perspective view of a mobile robot device according to an embodiment;

FIG. 5A is a perspective view illustrating a mobile robot device, a connecting module, and a fastening module according to an embodiment;

FIG. 5B is a perspective view illustrating a connecting module and a fastening device according to an embodiment;

FIGS. 5C and 5D are perspective views of a connecting assembly according to an embodiment;

FIG. 6 is an operational view illustrating a process of aligning a gas container through a clamping device by a gas supply system according to an embodiment;

FIG. 7A is an operational view illustrating a process of generating alignment information of a fastening device with respect to a gas container through a three-dimensional (3D) vision camera by a gas supply system according to an embodiment;

FIG. 7B is an example view of a 3D model of an end cap generated through a gas supply system according to an embodiment;

FIG. 7C is a schematic diagram illustrating a process of matching a 3D model generated through a processor with a reference image according to an embodiment;

FIG. 8 is a view illustrating a process of aligning a fastening device through a mobile robot device according to an embodiment;

FIG. 9 is a flowchart illustrating an automated fastening method according to an embodiment;

FIG. 10 is a flowchart illustrating an automated fastening method according to an embodiment; and

FIG. 11 is an operational flowchart of a gas supply system according to an embodiment.

### DETAILED DESCRIPTION

Hereinafter, embodiments will be described in detail with reference to the accompanying drawings. However, various alterations and modifications may be made to the embodiments. Here, the embodiments are not meant to be limited by the descriptions of the present disclosure. The embodiments should be understood to include all changes, equivalents, and replacements within the idea and the technical scope of the disclosure.

The terminology used herein is for the purpose of describing particular embodiments only and is not intended to be limiting. The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms including technical and scientific terms used herein have the same meaning as commonly understood by one of ordinary skill in the art to which the embodiments belong. Terms, such as those defined in commonly used dictionaries, are to be interpreted as having a meaning that is consistent with their meaning in the context of the relevant art and the present disclosure, and are not to be interpreted in an idealized or overly formal sense unless expressly so defined herein.

When describing the embodiments with reference to the accompanying drawings, like reference numerals refer to like components and a repeated description related thereto will be omitted. In the description of embodiments, detailed description of well-known related structures or functions will be omitted when it is deemed that such description will cause ambiguous interpretation of the present disclosure.

Also, in the description of the components, terms such as first, second, A, B, (a), (b) or the like may be used herein when describing components of the present disclosure. These terms are used only for the purpose of discriminating one component from another component, and the nature, the sequences, or the orders of the components are not limited by the terms. It should be noted that if one component is described as being “connected,” “coupled” or “joined” to another component, the former may be directly “connected,” “coupled,” and “joined” to the latter or “connected”, “coupled”, and “joined” to the latter via another component.

The same name may be used to describe an element included in the embodiments described above and an element having a common function. Unless otherwise mentioned, the descriptions of the examples may be applicable to the following examples and thus, duplicated descriptions will be omitted for conciseness.

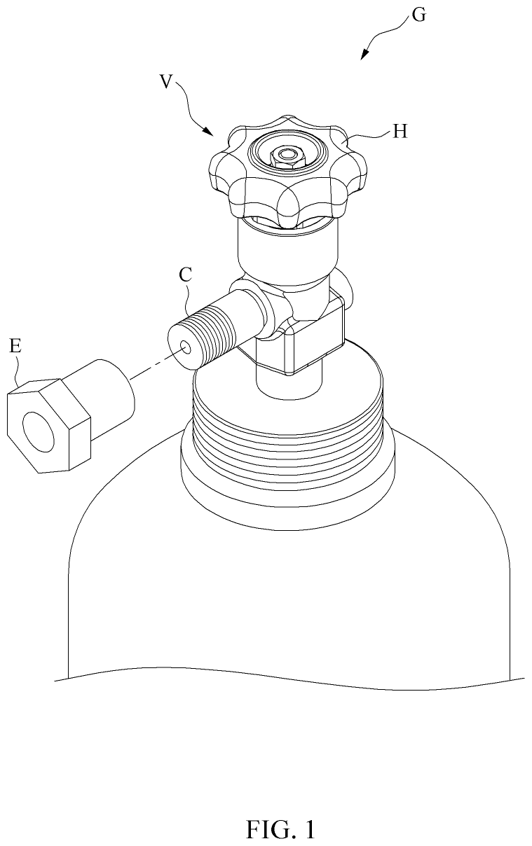

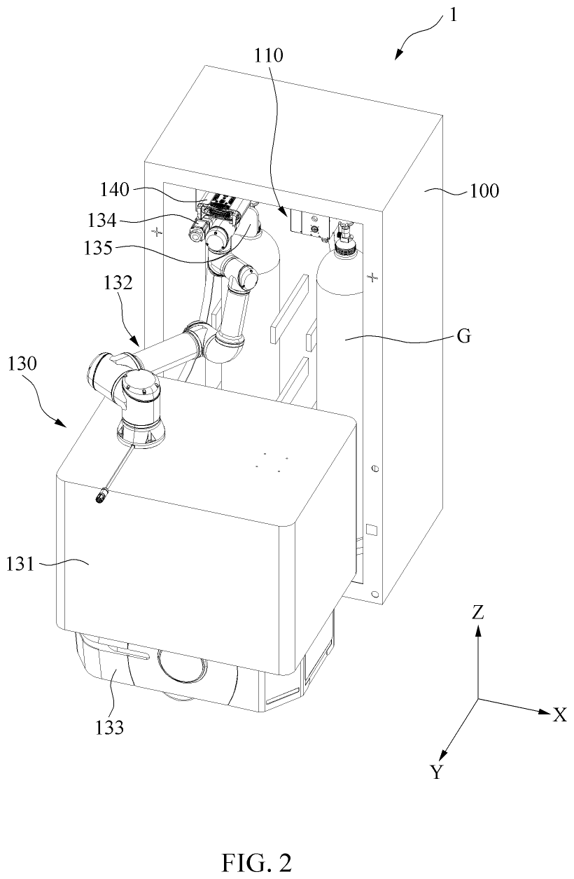

FIG. 1 is a perspective view of a portion of a gas container according to an embodiment. A gas container G used in an automated gas supply system 1 according to an embodiment will be described with reference to FIG. 1. In an embodiment, the gas container G may store a process gas therein. In an embodiment, a valve assembly V may be provided in the upper portion of the gas container G to discharge the gas stored therein or to inject a gas from the outside. In an embodiment, the valve assembly V may optionally regulate the gas flow, while providing a flow path to discharge the gas stored in the gas container G to the outside. In an embodiment, a valve C with an open outlet to discharge a gas to the outside may be formed to protrude from a side surface of the valve assembly V. In an embodiment, the valve C may be connected to a valve connector 112 of a fastening device 110 described below (e.g., the fastening device 110 of FIG. 2). In an embodiment, a valve shutter (not shown) may be provided in the valve assembly V to regulate gas flow through the valve C. The valve C shutter may regulate the gas flow through the valve C by rotating a valve handle H positioned in the upper portion of the valve assembly V.

In an embodiment, an end cap E may be mounted on the outer circumferential surface of the valve C of the gas container G to prevent gas leakage by covering the outlet. The end cap E may be mounted on the valve C to enclose the outer circumferential surface of the valve C. In an embodiment, the end cap may be screwed onto the valve C along the outer circumferential surface of the valve C to be mounted on the valve C or removed from the valve C. In an embodiment, the end cap E may have a polygonal cross section, but the shape of the cross section of the end cap E is not limited thereto.

In an embodiment, for the gas supply system 1 to receive the gas from the gas container G, the end cap E mounted on the valve C needs to be removed first. When a series of operations of receiving the gas from the gas container G is completed, the end cap E may be mounted again on the valve C of the gas container G to close the outlet.

In an embodiment, the gas container G may be fastened to the fastening device 110 of the gas supply system 1 while disposed at a set safe placing position. For example, the safe placing position may be the internal space of a cabinet 100 described below. In an embodiment, since the gas container G generally has great weight, the fastening device 110 may be fastened to the gas container G in such a manner that the fastening device 110 is aligned with the gas container G after the gas container G is disposed at the safe placing position. However, embodiments are not limited thereto.

Hereinafter, in describing the gas supply system 1, each component and operating method of the gas supply system 1 will be described on the premise that the gas container G is disposed at the set safe placing position.

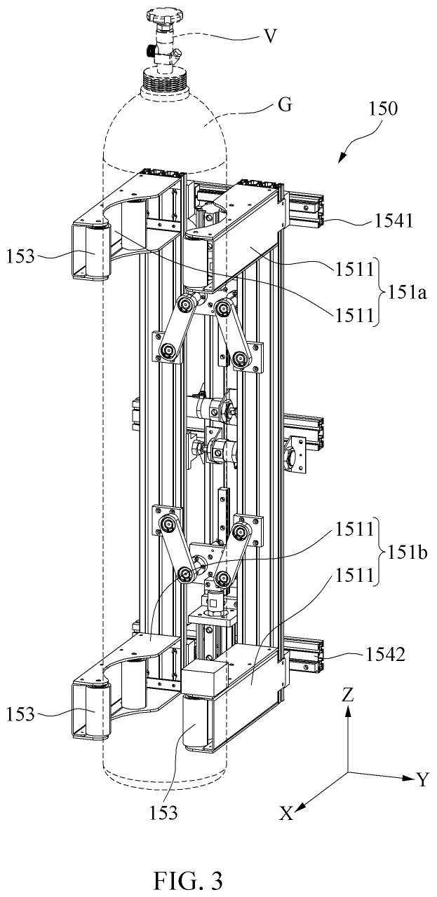

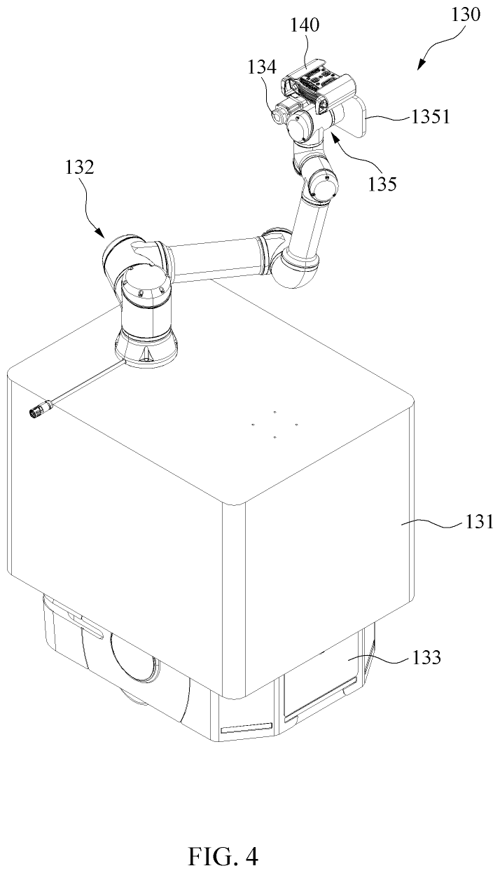

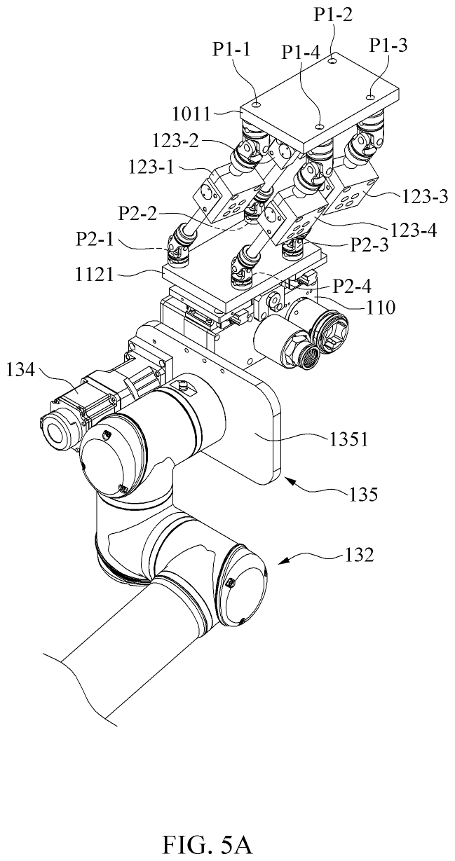

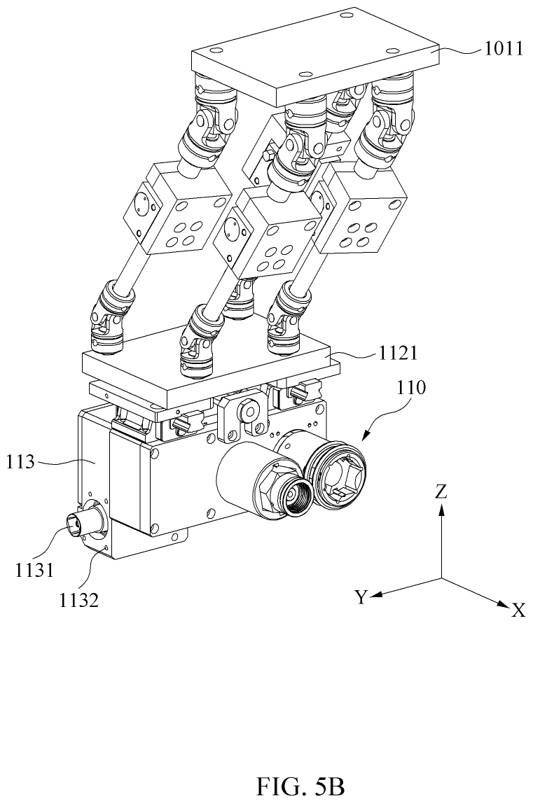

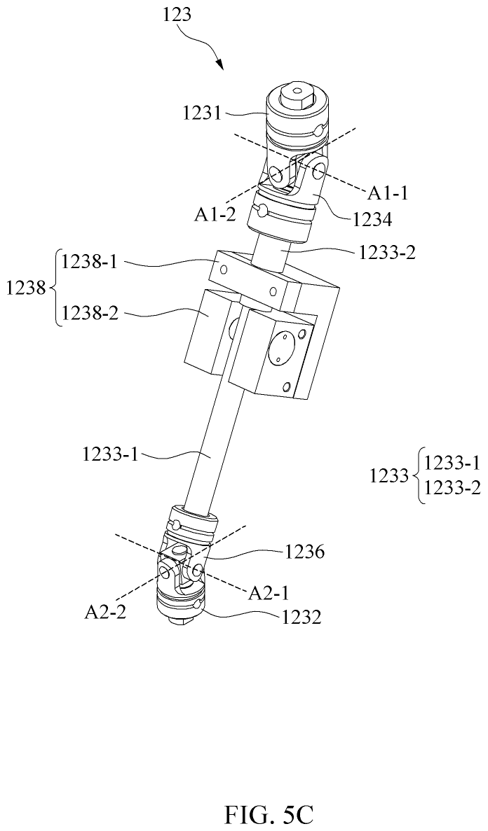

FIG. 2 is a perspective view of a gas supply system according to an embodiment. FIG. 3 is a perspective view of a clamping device according to an embodiment. FIG. 4 is a perspective view of a mobile robot device according to an embodiment. FIG. 5A is a perspective view illustrating a mobile robot device, a connecting module, and a fastening module according to an embodiment. FIG. 5B is a perspective view illustrating a connecting module and a fastening device according to an embodiment. FIGS. 5C and 5D are perspective views of a connecting assembly according to an embodiment.

Referring to FIGS. 2 to 5D, a gas supply system 1 according to an embodiment may be automatically fastened to a gas container G disposed in a set position to receive a gas. In an embodiment, the gas supply system 1 may automatically detach an end cap E from a valve C of the gas container G or automatically fasten the end cap E to the valve C. The gas supply system 1 may be automatically fastened to the valve C of the gas container G, thereby supplying a gas in the gas container G to a gas pipe.

In an embodiment, the gas supply system 1 may include a cabinet 100, a fastening device 110, a mobile robot device 130, a 3D vision camera 140, and a processor (not shown).

In an embodiment, the cabinet 100 may accommodate the gas container G therein. The cabinet 100 may form an internal space where the gas container G is disposed. The cabinet 100 may include a door portion (not shown) to open and close the internal space so that the gas container G may enter the internal space or the gas container G may leave the internal space after use. In the drawings, it is shown that the internal space of the cabinet 100 is open (e.g., in the +Y direction of the cabinet 100 of FIG. 2), but this is for ease of description. The internal space of the cabinet 100 may be opened and closed by the door portion that is not shown. The door portion may seal the internal space of the cabinet 100 to reduce or prevent the gas stored in the gas container G from leaking out of the cabinet 100, during a series of operations of receiving a gas as the gas container G disposed in the cabinet 100 is fastened to the fastening device 110.

In an embodiment, one or more gas containers G may be disposed in the cabinet 100. For example, as shown in FIG. 2, two gas containers G and two fastening devices 110 respectively fastened to the two gas containers G may be disposed in the cabinet 100. However, this is an example, and the number of gas containers G and the number of fastening devices 110 corresponding thereto are not limited and may be changed depending on the design. Hereinafter, the configuration of the gas supply system 1 will be described based on one gas container G and one fastening device 110 corresponding thereto disposed in the cabinet 100.

In an embodiment, a support (not shown) supporting the gas container G may be disposed on the floor surface of the internal space of the cabinet 100. In an embodiment, the support may rotate about an axis perpendicular to the ground while supporting the gas container G at its lower end.

In an embodiment, the fastening device 110 may be configured to detach or fasten an end cap (e.g., the end cap E of FIG. 1) from or to the valve C of the gas container G or to be fastened to the valve C of the gas container G to receive a gas. For example, the fastening device 110 may detach/mount the end cap from/on the valve of the gas container G while aligned in a first position with respect to the valve C of the gas container G. The fastening device 110 may be fastened to the valve C with the end cap removed while aligned in a second position with respect to the valve C of the gas container G, thereby connecting the gas container G and the gas pipe.

In an embodiment, the fastening device 110 may be fastened to the valve C while aligned with the valve C of the gas container G. In an embodiment, the fastening device 110 may include an end cap detacher 111 for removing the end cap from the valve C of the gas container G, a valve connector 112 fastened to the valve C of the gas container G to receive a gas, and a docking portion 113 connected to the mobile robot device 130 to receive power.

In an embodiment, the end cap detacher 111 may detach and remove the end cap E mounted on the valve C, or mount the end cap again on the valve C of the gas container G after use. In an embodiment, an insertion recess into which at least a portion of the end cap is inserted may be formed in the end cap detacher 111. The insertion recess may be formed in a shape corresponding to the cross section of the end cap. For example, when the end cap is formed to have a regular hexagonal cross section as shown in FIG. 1, the insertion recess formed in the end cap detacher 111 may be formed to have a regular hexagonal cross section corresponding to the cross section of the end cap so that the end cap may be inserted thereinto. In an embodiment, the end cap detacher 111 may rotate about a first rotation axis. The first rotation axis may be disposed to penetrate through the center of the insertion recess. In an embodiment, in a state in which the fastening device 110 is aligned with respect to the valve C at a first position, the first rotation axis of the end cap detacher 111 may coincide with the central axis of the end cap.

In an embodiment, in a state in which the fastening device 110 is aligned in a first state with respect to the valve C of the gas container G, the end cap detacher 111 may be placed in a state to detach the end cap from the valve C or mount the end cap thereon. For example, in a state in which the fastening device 110 is aligned in the first position with respect to the valve C of the gas container G, the end cap detacher 111 may be disposed to face the valve C in a state in which the first rotation axis A1 coincides with the central axis of the valve C, that is, the rotation center of the end cap mounted on the valve C.

In an embodiment, since the end cap is detached from and fastened to the valve C in a screwing manner, the end cap detacher 111 may unscrew the end cap from the valve C or screw the end cap onto the valve C by rotating about the first rotation axis while gripping the outer surface of the end cap through the insertion recess.

In an embodiment, for the end cap to be inserted into the insertion recess of the end cap detacher 111, the rotation angle of the end cap needs to be adjusted to match the shape of the insertion recess with the shape of the end cap in a state in which the first rotation axis coincides with the central axis. In an embodiment, the end cap detacher 111 may rotate about the first rotation axis through the power received from the mobile robot device 130 described below, thereby adjusting the rotation angle with respect to the end cap. For example, the first rotation axis of the end cap detacher 111 and the central axis of the end cap may coincide through the position adjustment of the fastening device 110, and the rotation angle of the end cap detacher 111 may be performed by a rotational motion of the end cap detacher 111 on the first rotation axis.

In an embodiment, when the axial coincidence and rotation angle adjustment of the end cap detacher 111 with respect to the end cap is completed, the end cap detacher 111 may advance toward the end cap along the first rotation axis and accommodate the end cap in the insertion recess. With the end cap inserted, the end cap detacher 111 may translate along the first rotation axis while rotating about the first rotation axis, thereby removing the end cap from the valve C. The end cap may be mounted again on the valve C by performing the end cap detaching operation reversely.

In an embodiment, the valve connector 112 may be connected to the gas pipe 150 and fastened to the valve C of the gas container G with the end cap removed, to receive a gas from the gas container G. In an embodiment, the valve connector 112 may operate to be fastened to the valve C, in a state in which the fastening device 110 is aligned in a second position with respect to the valve C of the gas container G. In the state in which the fastening device 110 is aligned in the second position with respect to the valve C of the gas container G, the valve connector 112 may be disposed to face the valve C. The valve connector 112 may be fastened to the valve C in such as manner of being screwed onto the valve C through threads formed on the outer circumferential surface of the valve C.

In an embodiment, the valve connector 112 may rotate along a second rotation axis A2. In an embodiment, the valve connector 112 may translate forward and backward along the second rotation axis A2. In an embodiment, the second rotation axis A2 of the valve connector 112 may substantially coincide with the central axis of the valve C in a state in which the fastening device 110 is aligned in the second position with respect to the valve C of the gas container G. In this case, the valve connector 112 may be fastened to the valve C by advancing toward the valve C along the second rotation axis A2. In an embodiment, the rotational and advancing motion of the valve connector 112 may be performed by the power received from the mobile robot device 130.

In an embodiment, the second rotation axis A2 of the valve connector 112 and the first rotation axis A1 of the end cap detacher 111 may be disposed in parallel substantially on the same plane. According to this structure, when the fastening device 110 translates in one direction in a state in which the fastening device 110 is aligned in the first state with respect to the valve C of the gas container G, for example, in a state in which the first rotation axis A1 of the end cap detacher 111 coincides with the central axis of the end cap, the fastening device 110 may be aligned in the second position with respect to the valve C of the gas container G. In this case, the valve connector 112 and the end cap detacher 111 may be disposed side by side.

In another example not shown in the drawings, the valve connector 112 and the end cap detacher 111 may be formed so that the second rotation axis A2 and the first rotation axis A1 coincide. For example, the valve connector 112 may be positioned inside the insertion recess of the end cap detacher 111 and formed to rotate about the same rotation axis as the end cap detacher 111. In this case, as the fastening device 110 translates along the first rotation axis A1 in a state in which the fastening device 110 is aligned in the first state with respect to the valve C of the gas container G, for example, in a state in which the first rotation axis A1 of the end cap detacher 111 coincides with the central axis of the end cap, the fastening device 110 may be aligned in the second state with respect to the valve C of the gas container G.

Meanwhile, the position and angle of the fastening device 110 in the first state of being aligned to detach/mount the end cap from/on the valve C and the position and angle of the fastening device 110 in the second state of being aligned to be fastened to the valve C may vary relatively according to the position and angle of the valve of the gas container C disposed in the cabinet 100.

In an embodiment, the docking portion 113 may be disposed to be exposed on the outer surface of the fastening device 110. For example, the docking portion 113 may be positioned on a side of the fastening device 110 facing the open portion of the cabinet 100 (e.g., a side of the fastening device 110 facing the +Y axis of FIG. 3A). In an embodiment, the mobile robot device 130 may be detachably connected to the docking portion 113.

In an embodiment, in a state in which the mobile robot device 130 is connected to the docking portion 113, the position of the fastening device 110 in the internal space of the cabinet 100 may be changed by the mobile robot device 130. In an embodiment, in a state in which the mobile robot device 130 is connected to the docking portion 113, the fastening device 110 may receive power supplied by the mobile robot device 130 through the docking portion 113 and operate the end cap detacher 111 and the valve connector 112.

In an embodiment, the docking portion 113 may include a docking clamp to which a docking module of the mobile robot device 130 is fastened, and a power transmitter to which a rotation shaft of a power motor 134 of the mobile robot device 130 is connected. In an embodiment, the docking clamp may hold the fastening state of the docking module to the docking portion 113 or release the fastening state so that the docking module is detached therefrom.

In an embodiment, the mobile robot device 130 may move outside the cabinet 100. The mobile robot device 130 may be detachably connected to the fastening device 110, and may move the fastening device 110 or supply power to the fastening device 110 in a state of being connected to the fastening device 110. In an embodiment, the mobile robot device 130 may include a body 131, a traveling portion 133, a robot arm 132, and a docking module 135.

In an embodiment, the body 131 may form the body of the mobile robot device 130. The components (e.g., an actuator, a controller, a communication device, etc.) for the operation of the mobile robot device 130 may be disposed inside the body 131. The body 131 may move along the ground.

In an embodiment, the traveling portion 133 may be disposed at the lower end of the body 131. The traveling portion 133 may move the body 131 along the ground. The traveling portion 133 may include, for example, a guide member that moves along a guide rail installed on the ground, or may include a rolling member that moves on the ground. In an embodiment, the traveling portion 133 may operate to move the mobile robot device 130 according to an instruction from the controller.

In an embodiment, the robot arm 132 may be installed on the body 131. In an embodiment, the robot arm 132 may be positioned on the upper portion of the body 131. In an embodiment, the robot arm 132 may be configured as a multi-joint arm that implements a motion in multiple degrees of freedom, for example, a motion in six degrees of freedom. For example, the robot arm 132 may implement a 3D motion with respect to the ground (e.g., a translational motion in the X-, Y-, and Z-axial directions) and an angular motion in three directions (e.g., a motion of roll, yaw, and pitch) through the operation of the multi-joint arm.

In an embodiment, the docking module 135 may be disposed at an end portion of the robot arm 132. In an embodiment, the docking module 135 may be detachably fastened to the fastening device 110.

In an embodiment, the docking module 135 may be provided in the form of a clamp that supports the fastening device 110 by gripping the outer circumferential surface of the fastening device 110. In this case, the mobile robot device 130 may adjust the position of the fastening device 110 through the operation of the robot arm 132, in a state of gripping the fastening device 110 through the docking module 135.

In an embodiment, the docking module 135 may be provided in a structure to be fastened to the fastening device 110 in a docking manner. In this case, the docking module 135 may be fastened to the docking portion 113 of the fastening device 110 through the operation of the robot arm 132. The docking module 135 may be fastened to the docking portion 113 to move the fastening device 110 according to the operation of the robot arm 132, and may provide power to the fastening device 110 in a state of being fastened to the fastening device 110. In an embodiment, the docking module 135 may include a docking plate 1351, a docking member 1353, and a power motor 134.

In an embodiment, the docking plate 1351 may be disposed at an end portion of the robot arm 132. In an embodiment, the docking plate 1351 may include a docking surface (e.g., the surface of the docking plate 1351 shown in FIG. 4B) that faces a surface (e.g., a surface facing the +Y axis of FIG. 3B) of the docking portion 113.

In an embodiment, the docking member (not shown) may be disposed on the docking surface of the docking plate 1351. For example, the docking member may be formed to protrude from the docking surface. In an embodiment, the docking member may be optionally fastened to the docking clamp 1132 of the docking portion 113. For example, the docking member may be inserted and fastened to the docking clamp 1132. In an embodiment, when a plurality of docking clamps 1132 are disposed on the surface of the docking portion 113, a plurality of docking members may be formed on the docking surface of the docking plate 1351 at positions respectively corresponding to the plurality of docking clamps 1132.

In an embodiment, the power motor 134 may be installed at an end portion of the robot arm. The rotation shaft of the power motor 134 may penetrate through the docking plate 1351 and protrude from the docking surface of the docking plate 1351. In an embodiment, in a state in which the docking module 135 is fastened to the docking portion 113, for example, in a state in which the docking member is fastened to the docking clamp 1132, the rotation shaft of the power motor 134 may be inserted into the power transmitter 1131 formed in the docking portion 113. The power motor 134 may transmit power to the fastening device 110 through the power transmitter 1131. The power transmitted from the power motor 134 may be transmitted to the end cap detacher 111 and the valve connector 112 of the fastening device 110.

In an embodiment, for the docking module 135 to be fastened to the docking portion 113 of the fastening device 110, the docking module 135 needs to be aligned in a position to be fastenable to the docking portion 113. In an embodiment, as shown in FIG. 5, in the state in which the docking module is aligned to be fastenable to the docking portion 113, the docking member 136 of the docking module and the rotation shaft of the power motor 134 may be disposed at positions corresponding to the docking clamp 1132 and the power transmitter 1131 of the docking portion 113, respectively. The fastening state in which the docking module 135 is fastenable to the docking portion 113 of the fastening device 110 may relatively vary depending on the position and angle of the fastening device 110 in the cabinet 100.

In an embodiment, in a state in which the docking module 135 is fastened to the docking portion 113 of the fastening device 110, the docking module 135 and the fastening device 110 may move as an integral body, so that the position of the fastening device 110 in the internal space of the cabinet 100 may be adjusted by the robot arm 132. For example, the relative position of the fastening device 110 with respect to the valve C of the gas container G may be adjusted by the robot arm 132.

Meanwhile, the drawings illustrate the mobile robot device 130 having one robot arm 132, but this is for ease of description. The mobile robot device 130 may include a plurality of robot arms 132 to perform different functions (e.g., fastening/detaching a gasket, adjusting the position of the 3D vision camera, docking with respect to the fastening device, docking with respect to the clamping device, etc.).

In an embodiment, the 3D vision camera 140 may collect images of the gas supply system 1. For example, the 3D vision camera 140 may collect 3D images including the docking module 135, the fastening device 110, and the valve C of the gas container G. The 3D vision camera 140 may acquire a 3D image of a valve area including the valve C of the gas container G. In an embodiment, the 3D vision camera 140 may be disposed at an end portion of the robot arm, for example, on an upper portion of the docking plate 1351. The 3D vision camera 140 may be disposed on the robot arm to collect front view images of the docking module facing the docking portion 113, for example, images in the direction of the docking surface of the docking plate 1351. In an embodiment, the image collection position of the 3D vision camera 140 is not limited to the example described above, and may be set to collect images in various directions depending on the set conditions. For example, the 3D vision camera 140 may be disposed on the robot arm to collect down view images of the docking module, for example, images in the direction of the ground of the docking plate 1351. Additionally, the 3D vision camera 140 may not be disposed on the robot arm but in a position adjacent to the robot arm.

In an embodiment, the processor may control the operation of the mobile robot device 130. In an embodiment, the processor may move the mobile robot device 130 based on the images collected by the 3D vision camera 140. For example, the processor may move the mobile robot device 130 toward the cabinet 100 or away from the cabinet 100.

In an embodiment, the processor may control the operation of the mobile robot device 130 so that the mobile robot device 130 may be fastened to the fastening device 110 based on 3D images collected by the 3D vision camera 140. For example, the processor may obtain information about the position and angle of the fastening device 110, and move and operate the robot arm 132 so that the mobile robot device 130 may grip the fastening device 110 or be fastened to the fastening device 110.

In an embodiment, the processor may operate the robot arm to dock the docking module 135 on the docking portion 113 of the fastening device 110 based on the images collected by the 3D vision camera 140. In an embodiment, the processor may adjust the position of the docking module 135 connected to the fastening device 110 by operating the robot arm 132 so that the fastening device 110 is aligned with respect to the valve C of the gas container G, based on the images collected by the 3D vision camera 140.

In an embodiment, the processor may determine an alignment position of the docking module 135 according to a set algorithm, and control the operation of the robot arm 132 so that the docking module 135 moves to the determined alignment position. An alignment position of the docking module 135 may include 3D coordinates and a 3D rotation angle thereof in the cabinet 100.

In an embodiment, the alignment position of the docking module 135 may very according to the purpose for each operation sequence of the gas supply system 1. In an embodiment, in the process of fastening the mobile robot device 130 to the fastening device 110, the alignment position of the docking module 135 may be a position at which the docking module 135 is in the fastening state of being relatively aligned to be fastenable to the fastening device 110, that is, at which the docking module 135 is aligned to be fastenable in response to the position and angle of the docking portion 113.

In an embodiment, in a state in which the mobile robot device 130 is fastened to the fastening device 110, that is, in a state in which the docking module 135 is fastened to the docking portion 113, the alignment position of the docking module 135 may be the 3D coordinates and 3D angle of the docking module 135 at which the fastening device 110 is in the first position with respect to the valve C of the gas container G. For example, the alignment position of the docking module at which the fastening device 110 is in the first position with respect to the valve C may be the position and angle of the docking module 135 at which the end cap detacher 111 of the fastening device 110 causes the first rotation axis to coincide with the central axis of the valve C in response to the position and angle of the valve of the gas container G.

In an embodiment, in a state in which the mobile robot device 130 is fastened to the fastening device 110, that is, in a state in which the docking module 135 is fastened to the docking portion 113, the alignment position of the docking module 135 may be an alignment position of the docking module 135 at which the fastening device 110 is in the second position with respect to the valve C of the gas container G. For example, the alignment position of the docking module at which the fastening device 110 is in the second position with respect to the valve C may indicate the position and angle of the docking module 135 at which the second rotation axis of the valve connector 112 of the fastening device 110 coincides with the central axis of the valve C in response to the position and angle of the valve of the gas container G.

In an embodiment, the processor may be configured to generate a 3D model 3M for a virtual space through the images acquired through the 3D vision camera 140. For example, the 3D model 3M generated by the processor may include 3D images according to the shapes of the docking module, the valve C of the gas container G, and the fastening device 110. In an embodiment, the generated 3D model 3M may vary in real time according to the images acquired by the 3D vision camera 140. In an embodiment, the processor may generate the 3D model 3M for a valve area of the gas container G. The valve area may be an area including a 3D image according to the shape of the valve C of the gas container G or the end cap mounted on the valve C.

In an embodiment, the processor may compare and match the generated 3D model 3M with one or more reference images BM stored in a database. For example, a reference image BM may be a 3D image of the docking portion 113 of the fastening device 110 viewed at a predetermined angle and position. For example, a reference image BM may be an actual image of the valve area, that is, an actual 3D image of the valve C and the end cap viewed at a predetermined angle and position. A plurality of reference images set based on different angles and positions may be stored in the database. Position information on a corresponding 3D model may be recorded in each reference image. For example, when a reference image includes an image of the docking portion 113, information about the position and angle of the docking portion 113 in the cabinet 100 may be recorded in the reference image. For example, information about a corresponding 3D model, that is, the 3D position coordinates and angle in the cabinet 100 for the valve or the end cap corresponding to the reference image may be recorded in each reference image.

In an embodiment, the processor may determine the position and angle state of the valve C of the gas container G based on the result of matching the generated 3D model 3M and the reference image BM, and adjust the position and angle of the fastening device 110 by operating the mobile robot device 130 so that the fastening device 110 may be positioned in a state to be fastenable to the valve C, for example, in a first alignment position in which the fastening device 110 is aligned to be capable of detaching/fastening the end cap or in a second alignment position in which the fastening device 110 is aligned to be fastened to the valve C and receive a gas.

In an embodiment, the processor may determine an image similarity between the 3D model generated through the set algorithm and a reference image stored in the database.

In an embodiment, the processor may control the mobile robot device 130 to dock the docking module on the docking portion of the fastening device 110 when the image similarity between the generated 3D model 3M and the reference image BM is greater than or equal to a set value. For example, if the reference image BM is a 3D model 3D in which the docking module 135 is aligned to be fastenable to the docking portion 113, the set algorithm may be set to generate an instruction to perform an operation of fastening the docking module to the docking portion 113 when the image similarity is greater than or equal to the set value.

In an embodiment, the processor may be configured to determine the alignment position of the fastening device 110 when a maximum image similarity between the generated 3D model 3M and the reference image BM is greater than or equal to the set value. The processor may operate the mobile robot device 130 so that the fastening device 110 is aligned according to the determined alignment position.

In an embodiment, when the alignment position of the fastening device 110 is determined according to the set algorithm, the processor may control the robot arm so that the position of the fastening device 110 connected to the mobile robot device 130 is adjusted to the determined alignment position. For example, the processor may control the robot arm to adjust the 3D coordinates and 3D rotation angle of the docking module 135 connected to the fastening device 110.

In an embodiment, during the process of detaching the end cap from the valve C, the processor may control the mobile robot device 130 so that the fastening device 110 is aligned in the first position with respect to the valve C of the gas container G when the image similarity between the generated 3D model 3M and the reference image BM is greater than or equal to the set value. In an embodiment, if the reference image BM is a 3D model 3M in a state in which the fastening device 110 is aligned in the first position with respect to the valve C, the set algorithm may be set to generate an instruction to operate the end cap detacher 111 to remove the end cap from the valve C when the image similarity is greater than or equal to the set value.

In an embodiment, during the process of fastening the fastening device 110 to the valve C, the processor may control the mobile robot device 130 so that the fastening device 110 is aligned in the second position with respect to the valve C of the gas container G when the image similarity between the generated 3D model 3M and the reference image BM is greater than or equal to the set value. In an embodiment, if the set reference image BM is a 3D model 3M in a state in which the fastening device 110 is aligned in the second position with respect to the valve C of the gas container G, the set algorithm may be set to generate an instruction to operate the valve connector 112 to be fastened to the valve C when the image similarity is greater than or equal to the set value.

In an embodiment, the processor may align the fastening device 110 through the operation of the robot arm 132 in a state in which the docking module 135 is fastened to the docking portion 113. In an embodiment, the processor may control the operation of the robot arm so that the fastening device 110 is in the first position with respect to the valve C of the gas container G, based on the images collected by the 3D vision camera 140. In an embodiment, the processor may control the power motor 134 to transmit power to the power transmitter 1131 when the fastening device 110 is aligned in the first position with respect to the valve C of the gas container G, thereby operating the end cap detacher 111. In an embodiment, the processor may control the operation of the robot arm so that the fastening device 110 is in the second position with respect to the valve C of the gas container G, based on the images collected by the 3D vision camera 140. In an embodiment, the processor may control the power motor 134 to transmit power to the power transmitter 1131 when the fastening device 110 is aligned in the second position with respect to the valve C of the gas container G, thereby operating the valve connector 112.

In an embodiment, the processor may be configured to perform an alignment operation determined according to the reference image BM having the maximum similarity to the generated 3D model 3M. For example, the processor may determine the position state of the valve C of the gas container G based on the position and angle information corresponding to the reference image BM, and generate alignment information on the alignment state of the fastening device 110 based on the determination result. The process of determining the image similarity between the 3D model 3M and the reference image BM will be described later.

In an embodiment, the gas supply system 1 may include a clamping device 150.

In an embodiment, the clamping device 150 may support the gas container G in the cabinet 100. In an embodiment, the clamping device 150 may clamp the outer circumferential surface of the gas container G, thereby preventing misalignment of the gas container G or tilting of the gas container G during the process of fastening the fastening device 110 to the gas container G. In an embodiment, the clamping device 150 may clamp the outer circumferential surface of the gas container G positioned on the upper portion of the support.

In an embodiment, the clamping device 150 may include one or more clamping portions 151a and 151b to optionally grip the outer circumferential surface of the gas container G positioned on the upper portion of the support. For example, the clamping device 150 may include a first clamping portion 151a and 151b to grip the upper circumference of the gas container G, and a second clamping portion 151a and 151b disposed under the first clamping portion 151a and 151b to grip the lower circumference of the gas container G. However, this is an example, and the clamping device 150 may include only one clamping portion 151a and 151b or may include three or more clamping portions 151a and 151b.

In an embodiment, each clamping portion 151a and 151b may include a pair of clamping members 1511 to support the gas container G from both sides. In an embodiment, the distance between the pair of clamping members 1511 may be adjusted. For example, the clamping portion 151a and 151b may include a guide rail disposed in a direction parallel to the ground, and the pair of clamping members 1511 may be movably connected along the guide rail. By moving the pair of clamping members 1511 along the guide rail to adjust the relative distance, the operation of clamping the gas container G through the clamping portion 151a and 151b may be performed. In an embodiment, the operation of moving the clamping members 1511 with respect to the guide rail may be performed by the power provided by a clamping driving motor (not shown). In an embodiment, one or more rolling members that are in contact with the gas container G and rotatable about an axis perpendicular to the ground may be disposed in each clamping member 1511. Each rolling member 153 may guide the rotational motion of the gas container G about the rotation axis perpendicular to the ground (e.g., the rotation axis of the support). In an embodiment, a plurality of rolling members 153 disposed in the clamping member 1511 may be connected to synchronize through a connecting link (not shown). The plurality of rolling members 153 may guide the rotational motion of the gas container G about the rotation axis perpendicular to the ground by rotating while synchronizing with each other through the connecting link. In an embodiment, the rolling member 153 may rotate the gas container G by receiving power from the robot arm. For example, the clamping device 150 may rotate the rolling member 153 as the docking portion 113 of the fastening device 110 described later is configured identically and the rotation axis of the mobile robot device 130 is connected. However, embodiments are not limited thereto, and a separate driving portion to provide rotational power may also be configured.

In an embodiment, the processor may operate the robot arm 132 to dock the docking module 135 on the clamping device based on the 3D images collected by the 3D vision camera 140. When docking is complete, the processor may rotate the gas container G by rotating the rolling member 153 by rotating the power motor 134 of the mobile robot device 130 based on the 3D images collected by the 3D vision camera 140, thereby aligning the end cap of the gas container G in a position matching a previously stored 3D image. For example, the processor may rotate the gas container so that the rotation angle of the gas container G compared to the image is within +25 degrees and the matching rate between images is 70% or higher.

In an embodiment, the processor may operate the mobile robot device 130 to rotate the clamping device to rotate the gas container when the maximum image similarity between the generated 3D model 3M and the reference image BM is less than or equal to the set value. The processor may rotate the clamping device until the image similarity between the 3D model 3M acquired while rotating the gas container G and the reference image BM is greater than or equal to the set value. Further, the process may rotate the gas container G until the generated 3D model 3M and the reference image BM have the maximum image similarity.

In an embodiment, the gas supply system 1 may include a connecting module 120.

In an embodiment, the connecting module 120 may movably connect the fastening device 110 to the cabinet 100. In an embodiment, the connecting module 120 may connect the fastening device 110 to the cabinet 100 so that the position and angle of the fastening device 110 is adjusted in the cabinet 100. In an embodiment, the connecting module 120 may include a fixed plate 1011, a supporting plate 1121, and a plurality of connecting assemblies 123. However, although it is described in an embodiment that a plurality of connecting assemblies 123 are provided, embodiments are not limited thereto, and at least one connecting assembly 123 may be configured. Hereinafter, the description will be provided based on one of the plurality of connecting assemblies 123.

In an embodiment, the fixed plate 1011 may be fixed to the internal space of the cabinet 100. For example, the fixed plate 1011 may be fixed to the top surface of the internal space. For example, the fixed plate 1011 may be fixed to one side of the inside of the cabinet 100 to form a first connecting portion 101 to which a connecting assembly 123 described later is connected. For example, the fixed plate 1011 may form the first connecting portion 101 to which a first end portion 121 of the connecting module 120 is connected on the surface thereof. However, embodiments are not limited to a case where the first connecting portion 101 is formed on the fixed plate 1011, and the first connecting portion 101 may be formed in a predetermined portion on the top surface of the cabinet 100.

In an embodiment, the supporting plate 1121 may be fixed to one side of the fastening device 110. For example, the supporting plate 1121 may be fixed to the top surface of the fastening device 110. For example, the supporting plate 1121 may be fixed to the top surface of the fastening device 110 to form a second connecting portion to which the connecting assembly 123 described later is connected. For example, the supporting plate 1121 may form the second connecting portion to which a second end portion 122 of the connecting module 120 is connected on the surface thereof. However, embodiments are not limited to a case where the second connecting portion is formed on the supporting plate 1121, and the second connecting portion may be formed in a predetermined portion on the top surface of the fastening device 110. In this case, the supporting plate 1121 may be movably and rotatably installed in the cabinet 100 through the connecting module 120 fixed to the upper end of the cabinet 100. In an embodiment, when the fixed plate 1011 is provided, the surface of the supporting plate 1121 may have substantially the same shape as the surface of the fixed plate 1011. In other words, the shape of the supporting plate 1121 and the shape of the fixed plate 1011 may be the same or similar.

In an embodiment, the connecting assembly 123 may movably and rotatably connect the fastening device 110 to the cabinet 100. For example, the connecting assembly 123 may be formed to have a longitudinal direction. In this case, the first end portion 121 of the connecting assembly 123 may be connected to the first connecting portion 101 of the cabinet 100. In this case, the second end portion 122 of the connecting assembly may be connected to the second connecting portion. For example, when the connecting module 120 has a plurality of connecting assemblies 123, each of the plurality of connecting assemblies 123 may be connected to different positions of the first connecting portion 101. For example, when the connecting module 120 has a plurality of connecting assemblies 123, each of the plurality of connecting assemblies 123 may be connected to different positions of the second connecting portion.

In an embodiment, the connecting assembly 123 may include a first connecting member 1231, a second connecting member 1232, a length-adjustable shaft 1233, a first joint 1234, a second joint 1236, and a brake 1238.

In an embodiment, the first connecting member 1231 may be connected to one predetermined point of the first connecting portion 101. For example, when the connecting module 120 includes a plurality of connecting assemblies 123, the first connecting members 1231 may be connected to different positions on the first connecting portion 101. In an embodiment, the second connecting member 1232 may be connected to one predetermined point of the second connecting portion. For example, when the connecting module 120 includes a plurality of connecting assemblies 123, the second connecting members 1232 may be connected to different positions on the second connecting portion.

In an embodiment, the length-adjustable shaft 1233 may connect the first connecting member 1231 and the second connecting member 1232 and may be adjusted in length. In an embodiment, the length-adjustable shaft 1233 may include a first length-adjustable member 1233-1, a second length-adjustable member 1233-2, and an elastic member.

In an embodiment, the first length-adjustable member 1233-1 and the second length-adjustable member 1233-2 may be formed to have a length direction. For example, the first length-adjustable member 1233-1 may form an internal space into which the second length-adjustable member 1233-2 is inserted in the longitudinal direction. In this case, the first length-adjustable member 1233-1 may have an inner diameter substantially the same as the outer diameter of the second length-adjustable member 1233-2. That is, the inner diameter of the first length-adjustable member 1233-1 and the outer diameter of the second length-adjustable member 1233-2 may be substantially the same. For example, the second length-adjustable member 1233-2 may be inserted into the internal space of the first length-adjustable member 1233-1, and the second length-adjustable member 1233-2 may be moved in the internal space of the first length-adjustable member 1233-1. In this case, the length of the length-adjustable shaft 1233 may be adjusted through relative movement of the first length-adjustable member 1233-1 and the second length-adjustable member 1233-2.

In an embodiment, the elastic member (not shown) may cushion shock that may occur during relative movement of the second length-adjustable member 1233-2 with respect to the first length-adjustable member 1233-1. For example, the elastic member may be disposed inside the first length-adjustable member 1233-1. In this case, the elastic member may apply elastic force to the second length-adjustable member 1233-2 inserted into the first length-adjustable member 1233-1. However, embodiments are not limited thereto, and the elastic member may be mounted through a spring post between the fixed plate 1011 and the supporting plate 1121.

In an embodiment, the first joint 1234 may rotatably connect the length-adjustable shaft 1233 and the first connecting member 1231. For example, the first joint 1234 may include a universal joint, a ball joint, or a spherical bearing. In an embodiment, the first joint 1234 may include a first-first rotating member 1234-1 connected to the first connecting member 1231 so as to rotate about a first-first rotation axis A1-1. In an embodiment, the first joint 1234 may include a first-second rotating member 1234-2 which is connected to the first-first rotating member 1234-1 so as to rotate about a first-second rotation axis A1-2 that is perpendicular to the first-first rotation axis A1-1, and to which the length-adjustable shaft 1233 is connected. In this case, the first-second rotating member 1234-2 may rotate about the first-second rotation axis A1-2, and the first-second rotation axis A1-2 may rotate about the first-first rotation axis A1-1. Accordingly, the length-adjustable shaft 1233 connected through the first-first rotating member 1234-1 and the first-second rotating member 1234-2 may rotate along an imaginary sphere with respect to the first connecting member 1231, that is, to have a predetermined angle on a spherical coordinate system.

In an embodiment, the second joint 1236 may rotatably connect the length-adjustable shaft 1233 and the second connecting member 1232. For example, the second joint 1236 may include a second-first rotating member 1236-1 connected to the second connecting member 1232 so as to rotate about a second-first rotation axis A2-1. In an embodiment, the second joint 1236 may include a second-second rotating member 1236-2 which is connected to the second-first rotating member 1236-1 so as to rotate about a second-second rotation axis A2-2 that is perpendicular to the second-first rotation axis A2-1, and to which the length-adjustable shaft 1233 is connected. To avoid redundancy, in describing the second joint 1236, the description of the first joint 1234 may be substantially identically applied thereto within a range not causing a conflict.

In an embodiment, the brake 1238 is mounted on the length-adjustable shaft 1233 and may limit the length adjustment of the length-adjustable shaft 1233. In an embodiment, the brake 1238 may limit the length adjustment by limiting the relative movement of the first length-adjustable member 1233-1 and the second length-adjustable member 1233-2. In an embodiment, the brake 1238 may include a first brake member 1238-1 fixed to the outer surface of the first length-adjustable member 1233-1. In an embodiment, the brake 1238 may include a second brake member 1238-2 connected to the first brake member 1238-1 and optionally in contact with the outer surface of the second length-adjustable member 1233-2 to fix the position of the second length-adjustable member 1233-2. In this case, the brake 1238 may be optionally in contact with the outer surface of the second length-adjustable member 1233-2 by operating the second brake 1238, and generate frictional force to limit the relative movement of the second length-adjustable member 1233-2 with respect to the first length-adjustable member 1233-1. For example, the brake 1238 may include a pneumatic brake 1238. However, the type of the brake 1238 is an example and not limited thereto, and one of ordinary skill in the art may make appropriate changes and modifications to limit the relative movement of the first length-adjustable member 1233-1 and the second length-adjustable member 1233-2.

In an embodiment, the connecting assembly 123 may include any one of a first bearing (not shown) or a second bearing (not shown).

In an embodiment, the first bearing member may be disposed between the first connecting member 1231 and the length-adjustable shaft 1233 and rotate about a first central axis. In this case, the first central axis may be an axis parallel to the longitudinal direction of the first connecting member 1231 or an axis parallel to the longitudinal direction of the length-adjustable shaft 1233. For example, when the first bearing member is connected to the first connecting member 1231, the first central axis may include an axis parallel to the longitudinal direction of the first connecting member 1231. For example, when the first bearing member is connected to the length-adjustable shaft 1233, the first central axis may include an axis parallel to the length direction of the length-adjustable shaft 1233. In an embodiment, the second bearing member may be disposed between the second connecting member 1232 and the length-adjustable shaft 1233 and rotate about a second central axis. In describing the second joint 1236, the description of the first joint 1234 may be substantially identically applied thereto within a range not causing a conflict.

In an embodiment, the connecting module 120 may include a plurality of connecting assemblies 123. For example, the connecting module 120 may include a first connecting assembly 123-1 with both ends connected to a first-first point P1-1 of the first connecting portion 101 and a second-first point P2-1 of the second connecting portion, a second connecting assembly 123-2 with both ends connected to a first-second point P1-2 of the first connecting portion 101 and a second-second point P2-2 of the second connecting portion, a third connecting assembly 123-3 with both ends connected to a first-third point P1-3 of the first connecting portion 101 and a second-third point P2-3 of the second connecting portion, and a fourth connecting assembly 123-4 with both ends connected to a first-fourth point P1-4 of the first connecting portion 101 and a second-fourth point P2-4 of the second connecting portion. In this case, the connection positions of the plurality of connecting assemblies 123 for the first connecting portion 101 may correspond to the connection positions of the plurality of connecting assemblies 123 for the second connecting portion, respectively. In an embodiment, in a state in which the first connecting portion 101 and the second connecting portion are viewed so as to overlap each other, the plurality of connecting assemblies 123 may be disposed so as not to intersect each other. In this case, the fastening device 110 may be freely movably and rotatably connected to the fixed plate 1011 due to the plurality of connecting assemblies 123 that do not intersect each other.

In an embodiment, the plurality of connecting assemblies 123 may be connected to predetermined positions of the first connecting portion 101 and the second connecting portion, within a range in which the fastening device 110 is freely movable and rotatable with respect to the first connecting portion 101. For example, the connection positions at which the plurality of connecting assemblies 123 are connected to the first connecting portion 101 may be equidistant from an imaginary first reference point positioned on the first connecting portion 101, and the connection positions at which the plurality of connecting assemblies 123 are connected to the second connecting portion may be equidistant from an imaginary second reference point positioned on the second connecting portion. In this case, the distance from the first reference point and the distance from the second reference point may be the same or different. For example, the connection points of the plurality of connecting assemblies 123 for the first connecting portion 101 may form the vertices of an imaginary first quadrangle, and the connection points of the plurality of connecting assemblies 123 for the second connecting portion may form the vertices of a second quadrangle in the same shape as the first quadrangle. In this case, the first quadrangle and the second quadrangle may have the same shape, and the plurality of connecting assemblies 123 may be arranged in a direction perpendicular to the torque generated when the gas container G is fastened. In this case, the connecting module 120 may effectively transmit repulsive force for the torque to the cabinet 100.

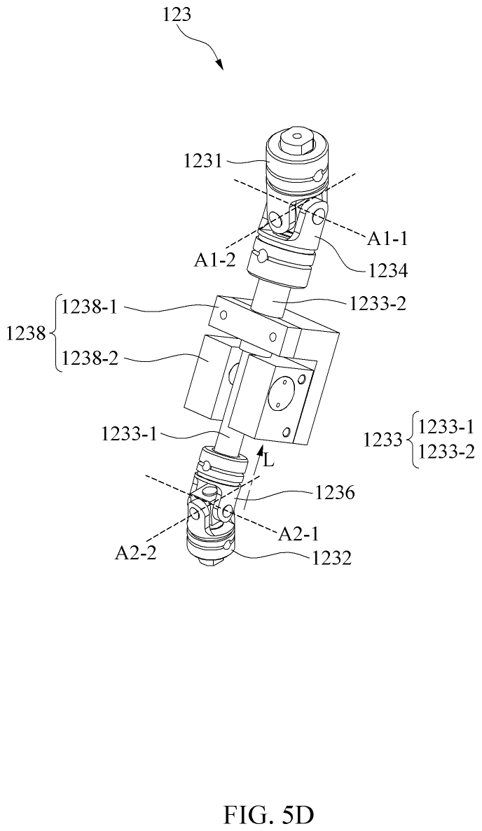

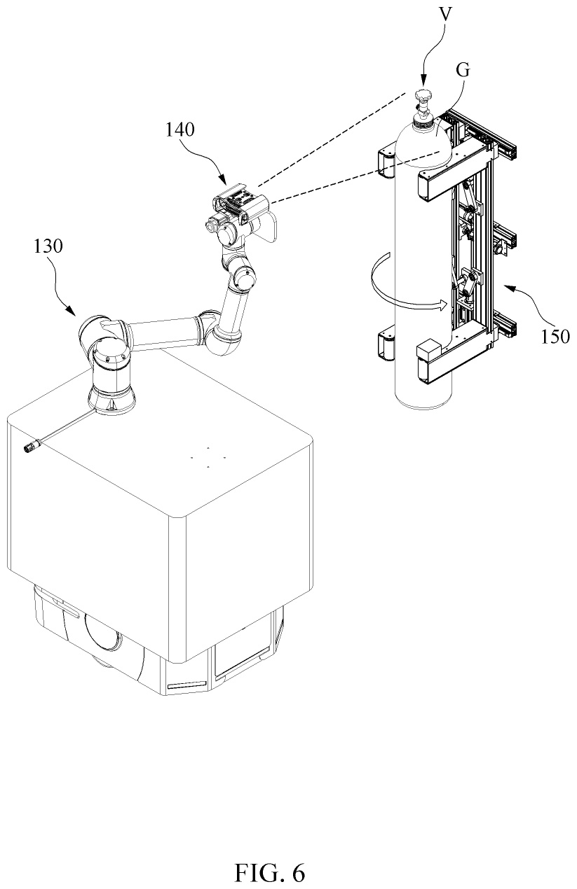

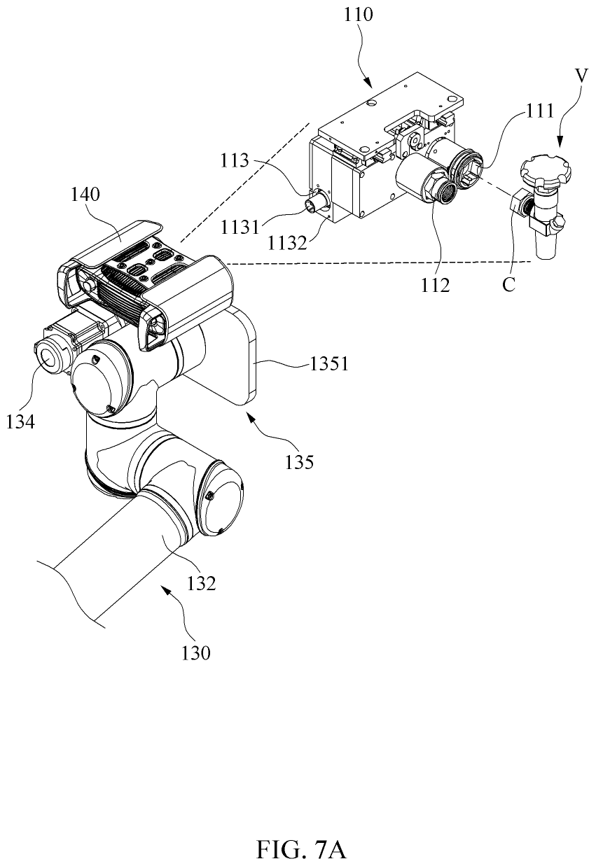

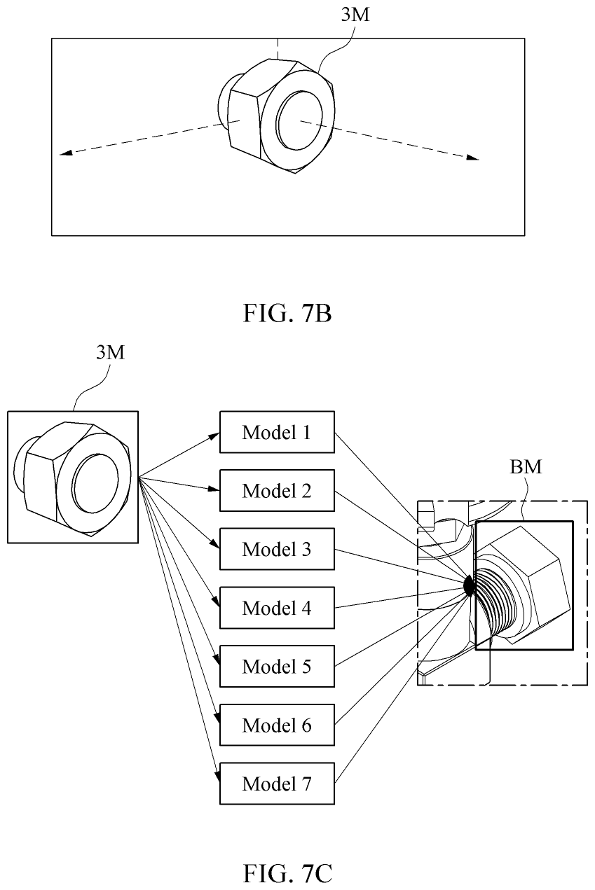

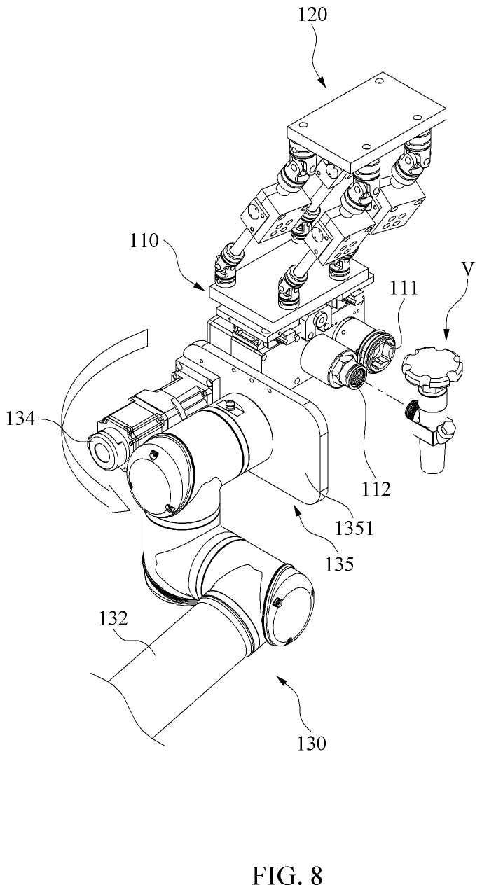

FIG. 6 is an operational view illustrating a process of aligning a gas container through a clamping device by a gas supply system according to an embodiment. FIG. 7A is an operational view illustrating a process of generating alignment information of a fastening device with respect to the gas container through the 3D vision camera 140 by the gas supply system according to an embodiment. FIG. 7B is an example view of a 3D model of an end cap generated through the gas supply system according to an embodiment. FIG. 7C is a schematic diagram illustrating a process of matching a 3D model generated through a processor with a reference image according to an embodiment. FIG. 8 is a view illustrating a process of aligning the fastening device through a mobile robot device according to an embodiment.

Hereinafter, a series of exemplary operations in which the gas supply system 1 is automatically fastened to the gas container G based on images acquired through the 3D vision camera 140 will be described with reference to FIGS. 6 to 8.

Referring to FIG. 6, in an embodiment, the gas supply system 1 may align the gas container G based on the images acquired through the 3D vision camera 140. In an embodiment, in a state in which the gas container G is safely placed on a support (not shown), the clamping device may support the outer circumferential surface of the gas container G and rotate the gas container G about a rotation axis perpendicular to the ground. For example, the clamping device may rotate the gas container G about a rotation axis perpendicular to the ground through the rotational motion of the rolling members 153 arranged on the clamping member 1511.

In an embodiment, the processor may adjust the rotational state of the gas container G through the clamping device. For example, the processor may rotate the gas container G about the rotation axis perpendicular to the ground through the clamping device, and acquire in real time an image of an end cap mounted on the valve V of the gas container G through the 3D vision camera 140 during the process of rotating the gas container G. The 3D vision camera 140 may acquire the image of the end cap at a set position. Since the gas container G rotates about the rotation axis, the 3D vision camera 140 may acquire an image of the end cap for each rotation angle of the gas container G about the rotation axis. In an embodiment, the processor may determine image similarities according to respective end cap images by comparing the acquired plurality of images of the end cap with a reference image BM of the end cap stored in a database. In an embodiment, the processor may select an image of the end cap having the highest similarity to the reference image BM of the end cap, and operate the clamping device so that the gas container G is positioned at a rotation angle corresponding to the selected end cap. For example, the image of the end cap acquired through the 3D vision camera 140 when the gas container G is positioned at a predetermined angle may have the highest similarity to the reference image BM of the end cap stored in the database. In a state in which the acquired image of the end cap has the highest similarity to the reference image BM, the rotation angle of the gas container G with respect to the rotation axis may be adjusted.

In an embodiment, when the rotation angle of the gas container G is adjusted, the gas supply system 1 may detect the alignment state of the fastening device 110 with respect to the valve C of the gas container G, as shown in FIGS. 7A to 7C. In an embodiment, the gas supply system 1 may acquire images including the valve C area (e.g., the valve C and the end cap) of the gas container G and the fastening device 110 through the 3D vision camera 140, and generate a 3D model 3M for a target area based on the acquired images. For example, the gas supply system 1 may generate the 3D model 3M for the shape of the end cap mounted on the valve C of the gas container G.

In an embodiment, the processor may determine the alignment state of the fastening device 110 with respect to the valve C of the gas container G by matching the generated 3D model 3M, for example, the 3D model 3M of the end cap, with a plurality of reference images BM stored in the database. For example, the processor may compare the generated 3D model 3M with the plurality of reference images BM previously stored in the database, and, based on the image similarity determination result, select a 3D reference image BM having the highest image similarity to the generated 3D model 3M. Here, the plurality of reference images BM may be 3D reference images BM of the valve C of the gas container G or the end cap having different shapes.

In an embodiment, the processor may divide the generated 3D model 3M and the selected 3D reference image BM into a plurality of pixel areas, and individually determine whether each pixel area matches. The processor may determine the image similarity between the selected 3D image and the reference image BM based on the matching states of the plurality of pixel areas of the generated 3D model 3M and the selected reference image BM. The processor may obtain the rotated angle and position coordinates on the 3D model 3M and the reference image BM generated simultaneously with the similarity determination.

In an embodiment, the processor may determine the position and angle state with respect to the valve C area of the gas container G based on the rotation angle and position information of the generated 3D model 3M, for example, the position adjustment value of the generated 3D image compared to the initial state of the 3D model 3M. The processor may generate alignment information about the movement coordinates and rotation angle for the fastening device 110 to be aligned with respect to the gas container G, based on the rotation angle and position information of the generated 3D model 3M corresponding to the generated 3D image.

In an embodiment, the processor may be configured to generate alignment information of the fastening device 110 only when the image similarity between the generated 3D model 3M and the reference image BM is greater than or equal to a set value. For example, if the maximum image similarity according to the image matching result is less than the set value, the processor may control the 3D vision camera 140 to re-acquire an image of the valve C area of the gas container G at a different position, rather than generating alignment information of the fastening device 110. For example, the processor may control to rotate the gas container G or adjust the capturing angle of the 3D vision camera 140 with respect to the valve C area of the gas container G.

In an embodiment, the processor may operate to generate alignment information of the fastening device 110 only when the rotation angle of the generated 3D model 3M corresponding to the 3D reference image BM, for example, the rotation angle of the 3D reference image BM compared to the initial state of the 3D model 3M, is within a set angle range. For example, if the rotation angle of the generated 3D model 3M corresponding to the 3D reference image BM exceeds the set angle, the processor may re-perform the operation of generating a 3D model 3M of the fastening device 110 and matching the 3D model 3M with the reference image BM.

In an embodiment, the processor may generate a movement path for aligning the fastening device 110 optimally with respect to the gas container G based on the alignment information generated according to image matching. The processor may control the operation of the mobile robot device 130 so that the position of the fastening device 110 may be adjusted according to the generated movement path.

In an embodiment, when the alignment information of the fastening device 110 and the movement path are generated, the processor may control the operation of the mobile robot device 130 so that the docking module 135 of the mobile robot device 130 is docked on the docking portion of the fastening device 110. As shown in FIG. 8, when the mobile robot device 130 is docked on the fastening device 110, the processor may control the mobile robot device 130 to align the fastening device 110 with respect to the valve C of the gas container G, for example, to place the fastening device 110 in a first alignment position to be capable of detaching the end cap.

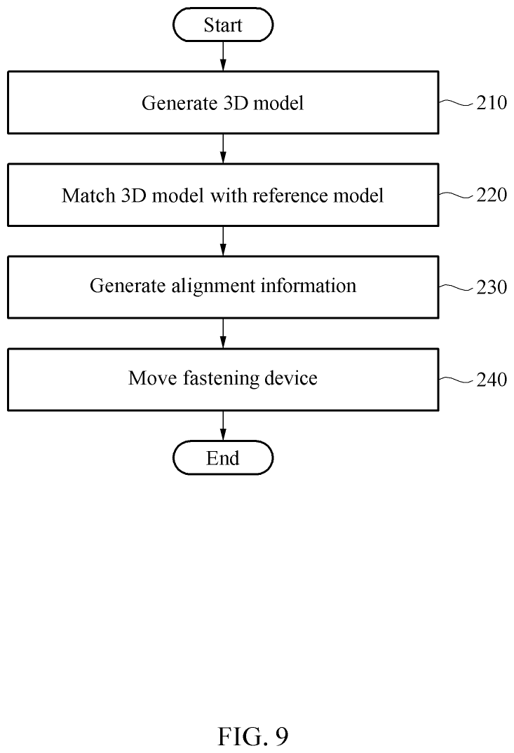

FIG. 9 is a flowchart illustrating a method of automatically fastening the fastening device 110 to the gas container G according to an embodiment.

At least one of the operations of the automated fastening method shown in FIG. 9 may be omitted. The operations of the automated fastening method may be performed in a different order or at the same time, unless otherwise specified. At least one of the operations of the automated fastening method may be performed repeatedly.

The automated fastening method according to an embodiment may be performed by the gas supply system 1 (e.g., the gas supply system 1 of FIG. 2) including the fastening device 110 and the mobile robot device 130 including the docking module optionally connected to the fastening device 110 to supply power to the fastening device 110. In an embodiment, the fastening device 110 may include a valve connector 112 fastened to a valve C of a gas container G to receive a gas, or an end cap detacher 111. In an embodiment, the mobile robotic device 130 may include the docking module that is optionally connected to the docking portion of the fastening device 110 to supply power to the fastening device 110. In an embodiment, the automated fastening method may be performed by a processor.

In an embodiment, the automated fastening method may include operation 210 of generating a 3D model 3M for an end cap of the gas container G. Operation 210 may be performed through a 3D vision camera 140. In an embodiment, in operation 210, the processor may acquire an image of the end cap of the gas container G through the 3D vision camera 140, and generate the 3D model 3M for the end cap based on the acquired image.

In an embodiment, the automated fastening method may include an operation of matching the generated 3D model 3M of the end cap with one of reference images BM stored in a database. The reference images BM may be actual 3D images or 3D images of a plurality of types of end caps captured from different angles. In an embodiment, in operation 220, pixels of the 3D image may be generated by dividing the generated 3D image into two-dimensional images, and an image similarity may be determined by comparing the generated pixels with image pixels of a reference image BM. In an embodiment, in operation 220, the rotation angle and 3D coordinates of the 3D model 3M generated based on the determined image similarity may be obtained.

In an embodiment, in operation 221, pixels may be obtained by dividing the generated 3D model two-dimensionally, and pixels of a 3D image of a geometric structure may be generated by combining the obtained pixels.

In an embodiment, in operation 220, the image similarity may be determined by comparing the generated pixels of the 3D image with images of the reference image BM. For example, the determination of the image similarity may be configured to divide the 3D image into a plurality of pixel areas, match the pixel areas with the images of the reference image BM, and generate a numerical value of the image similarity according to the number of matching pixel areas.

In an embodiment, in operation 220, whether it has the highest image similarity to the reference image BM may be determined. In operation 220, if the value of the highest image similarity is less than a set reference value, operation 210 may be performed again.

In an embodiment, the automated fastening method may include operation 230 of generating alignment information about the position and angle at which the end cap detacher 111 may be aligned with respect to the end cap, based on the result of matching the reference image BM and the 3D model 3M. In an embodiment, operation 230 may be performed only if the image similarity determined in operation 220 is greater than or equal to the set reference value.

In an embodiment, the automated fastening method may include operation 240 of moving the fastening device 110 to be aligned with the valve C (e.g., the end cap) of the gas container G based on the generated alignment information.

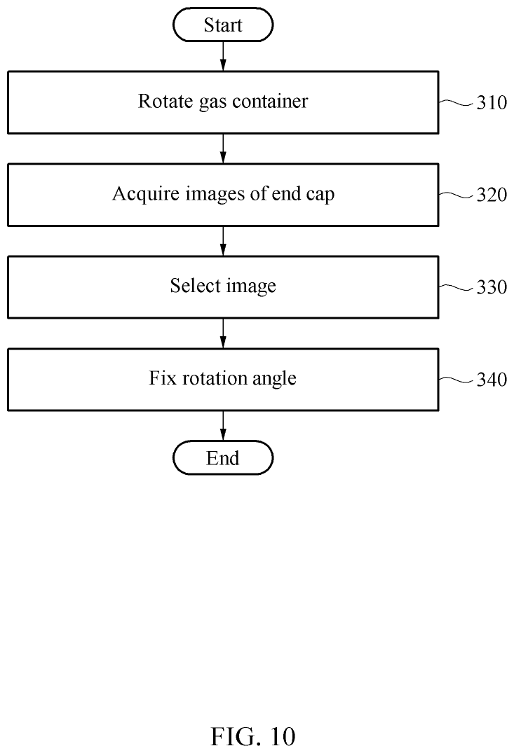

FIG. 10 is a flowchart illustrating a method of automatically fastening a fastening device to a gas container according to an embodiment.

At least one of the operations of the automated fastening method shown in FIG. 10 may be omitted. The operations of the automated fastening method may be performed in a different order or at the same time, unless otherwise specified. At least one of the operations of the automated fastening method may be performed repeatedly.

The automated fastening method according to an embodiment may be performed by the gas supply system 1 (e.g., the gas supply system 1 of FIG. 2) including a clamping device configured to support the gas container G to rotate about a rotation axis perpendicular to the ground and the 3D vision camera 140 to acquire an image of the gas container G. In an embodiment, the automated fastening method may be performed by a processor.

In an embodiment, the automated fastening method may include operation 310 of rotating the gas container G about a rotation axis perpendicular to the ground. Operation 310 may be performed through the clamping device.

In an embodiment, the automated fastening method may include, while operation 310 is performed, operation 320 of acquiring images of an end cap mounted on a valve C of the gas container G at a set position through a 3D vision camera 140.

In an embodiment, the automated fastening method may include operation 330 of comparing the acquired images of the end cap with a reference image BM of an end cap stored in a database, and selecting an image of the end cap having the highest image similarity to the reference image BM. In operation 330, an image of the end cap having the highest image similarity to the set reference image BM, that is, an image of the end cap in a state in which the gas container G is rotated by a predetermined angle about the rotation axis may be selected.

In an embodiment, the automated fastening method may include operation 340 of aligning the rotation angle of the gas container G about the rotation axis at a rotation angle corresponding to the selected image of the end cap. In operation 340, the processor may determine the rotation angle of the gas container G about the rotation axis by stopping the operation of the clamping device.

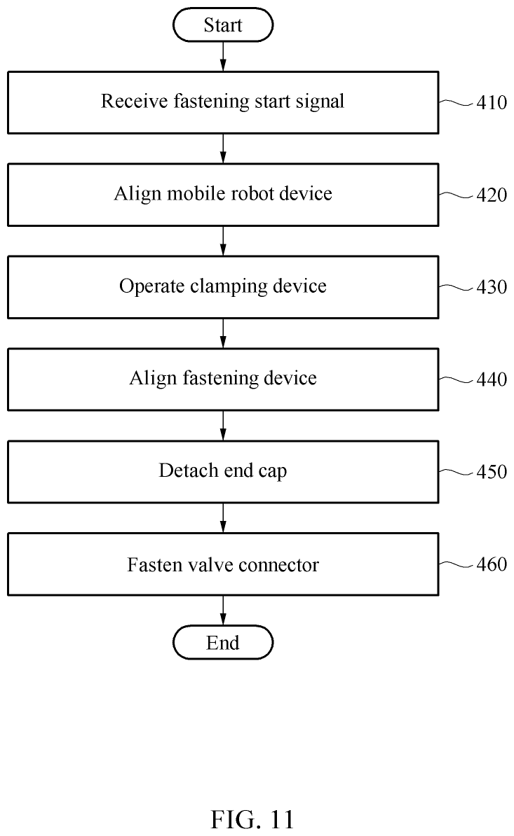

FIG. 11 is an exemplary operational flowchart of the gas supply system 1 according to an embodiment.

The operations of the gas supply system 1 shown in FIG. 11 may be performed in a different order or at the same time, unless otherwise specified. At least one of the operations shown in FIG. 11 may be performed repeatedly. The operations of the gas supply system 1 of FIG. 11 may be performed through the gas supply system 1 described above.

In an embodiment, the operating method of the gas supply system 1 may include operation 410 of receiving a fastening start signal. In operation 410, the gas supply system 1 may determine whether an operation of fastening the fastening device 110 to the gas container G is needed. For example, whether the fastening device 110 needs to be fastened to the gas container G may be determined based on an image acquired through the 3D vision camera 140 mounted on the mobile robot device 130. In operation 410, the mobile robot device 130 may move toward the cabinet 100. The mobile robot device 130 may recognize the gas container G disposed in the cabinet 100. In an embodiment, when the gas container G disposed in the cabinet 100 needs to be replaced, a signal regarding whether the gas container G needs to be replaced may be generated and transmitted to a processor. In an embodiment, when a plurality of gas containers G are disposed in the cabinet 100, whether a gas container G used at short intervals needs to be replaced may be performed first.

In an embodiment, when a signal for the fastening signal is received in operation 410, the mobile robot device 130 may move to a set position adjacent to the cabinet 100. The processor may determine the relative position of the mobile robot device 130 with respect to the cabinet 100 based on information about the position of the mobile robot device 130. In an embodiment, when it is determined that the mobile robot device 130 reaches the set position adjacent to the cabinet 100, an arrival signal may be transmitted to an operating server (e.g., the processor, an external server, etc.) of the gas supply system 1. The operating server may generate an instruction for an automated fastening sequence through the mobile robot device 130 and transmit the instruction to the processor.

In an embodiment, the operating method of the gas supply system 1 may include operation 420 of aligning the mobile robot device 130. For example, operation 420 may be performed after a start signal of the automated fastening sequence is generated from the operating server. In an embodiment, the processor may control the mobile robot device 130 to place the mobile robot device 130 at the set position adjacent to the cabinet 100 (i.e., the set fastening operation start position). In an embodiment, the processor may determine, through the mobile robot device 130 and the 3D vision camera 140, whether the mobile robot device 130 is placed at the set position or whether the mobile robot device 130 is in a predetermined abnormal situation (e.g., a dangerous situation requiring an interruption of the fastening sequence). In an embodiment, during the process of performing operation 420, the cabinet 100 may be opened so that the gas container G may be exposed to the outside.

In an embodiment, the operating method of the gas supply system 1 may include, after operation 420 is performed, operation 430 of aligning the gas container G through a clamping device. In an embodiment, in operation 430, the processor may verify the docking position of the mobile robot device 130 with respect to the clamping device through the 3D vision camera 140. In an embodiment, the mobile robot device 130 may be docked on the clamping device to provide power for operation of the clamping device. In another example, the clamping device may be operated by a power device provided by itself.

In an embodiment, in operation 430, the processor may detect the presence of the gas container G in the cabinet 100 through the 3D vision camera 140. If it is determined that the gas container G is present in the cabinet 100, the processor may capture an image of the valve C area of the gas container G, for example, an end cap mounted on the valve C, through the 3D vision camera 140. In an embodiment, in operation 430, the clamping device may rotate the gas container G about a rotation axis perpendicular to the ground while the 3D vision camera 140 captures the end cap of the gas container G at a set position. The processor may acquire, for each angle, an image of the end cap that changes according to the rotational motion of the gas container G, and determine an image similarity by comparing the acquired image of the end cap with a reference image BM stored in a database. In an embodiment, in operation 430, the processor may select an image of the end cap, captured at a rotation angle of the gas container G, having the highest similarity to the reference image BM. In an embodiment, when the image of the end cap having the highest similarity to the reference image BM is selected in operation 430, the processor may stop the gas container G at a rotation angle corresponding to the selected image through the clamping device. In this case, the rotational alignment of the gas container G may be completed only when the similarity between the reference image BM and the image of the end cap has a matching rate greater than a set reference value, for example, 70%. For example, if the highest image similarity is less than the set reference value, it may be determined that the gas container G is absent or that the cylinder valve C (e.g., the end cap) is defective, and an alarm for the abnormal state may be generated.

In an embodiment, in operation 430, when the rotational alignment of the gas container G is completed, operation of the clamping device may be stopped. When the clamping device is operated through the mobile robot device 130, the mobile robot device 130 may be separated from the clamping device. In operation 430, information about the position of the end cap may be transmitted to the processor.

In an embodiment, the operating method of the gas supply system 1 may include, after operation 430 is performed, operation 440 of aligning the fastening device 110 with respect to the gas container G.

In an embodiment, in operation 440, the processor may obtain position information of a target area of the fastening device 110, for example, the end cap detacher 111 and the valve connector 112, through the 3D vision camera 140. In operation 440, the processor may connect the mobile robot device 130 to the docking portion of the fastening device 110. In operation 440, the processor may detach a plug blocking a connector of the mobile robot device by rotating the connector. In operation 440, the processor may align the fastening device 110 in a position to be fastenable to the valve C of the gas container G, that is, the end cap, based on information about the relative position and rotation angle of the fastening device 110 with respect to the end cap. Since the position and angle of the fastening device 110 may be adjusted through multi-degree-of-freedom movement inside the cabinet 100 by a mobile module, the fastening device 110 may be aligned with the valve C of the gas container G by the operation of the mobile robot device docked on the fastening device 110. For example, the fastening device 110 may be aligned in a first alignment state to detach the end cap from the gas container G.

In an embodiment, the operating method of the gas supply system 1 may include, after operation 440 is performed, operation 450 of detaching the end cap from the gas container G through the fastening device 110. In operation 450, the processor may control the mobile robot device 130 so that the end cap is inserted into the end cap detacher 111 of the fastening device 110. In a state in which the end cap is inserted into the end cap detacher 111, the processor may operate the power motor 134 of the mobile robot device 130 to apply power to the end cap detacher 111 of the fastening device 110. According to the rotational motion of the end cap detacher 111, the end cap may be detached from the valve C of the gas container G.

In an embodiment, the operating method of the gas supply system 1 may include, after operation 450 is performed, operation 460 of detaching the end cap from the gas container G through the fastening device 110.

In an embodiment, when the end cap is detached from the valve C of the gas container G, the processor may adjust the position of the fastening device 110 through the mobile robot device 130 so that the fastening device 110 is in a second alignment state to be fastenable to the valve C of the gas container G, for example, the central axis of the valve C connector coincides with the valve C axis of the gas container G. In this case, the processor may control a separate mobile robot device 130 to mount a gasket on the valve C of the gas container G with the end cap removed. In an embodiment, in a state in which the gasket is mounted on the valve C of the gas container G, the processor may move the fastening device 110 through the mobile robot device 130 so that the valve connector 112 of the fastening device 110 is fastened to the valve C of the gas container G. In a state where the valve connector 112 is fastened to the valve C of the gas container G, the processor may apply power to the fastening device 110 through the power motor 134, thereby rotatably coupling the valve connector 112 to the valve C of the gas container G.

A number of embodiments have been described above. Nevertheless, it should be understood that various modifications and variations may be made to these embodiments. For example, suitable results may be achieved if the described techniques are performed in a different order, and/or if components in a described system, architecture, device, or circuit are combined in a different manner, and/or replaced or supplemented by other components or their equivalents.

Therefore, other implementations, other embodiments, and/or equivalents of the claims are within the scope of the following claims.

What is claimed is:

1. A gas supply system comprising:
a cabinet in which a gas container is disposed;
a fastening device movable with respect to the gas container and fastenable to a valve of the gas container while aligned with the valve;
a mobile robot device detachably connected to the fastening device and configured to move the fastening device;
a three-dimensional (3D) vision camera configured to collect an image; and
a processor configured to control an operation of the mobile robot device based on the image collected by the 3D vision camera,
wherein the mobile robot device comprises:
a body movable outside the cabinet; and
a robot arm installed on an upper portion of the body, the robot arm comprising a multi-joint arm, and
the processor is configured to
generate a 3D model for a valve area of the gas container in real time through the 3D vision camera, match the generated 3D model with any one reference image stored in a database, determine a position and angle state of the valve of the gas container based on the matched reference image, and operate the mobile robot device to align the fastening device in a state to be fastenable with respect to the valve based on a result of the determining.

2. The gas supply system of claim 1, wherein the processor is configured to generate a 3D model comprising a shape of the valve of the gas container or a shape of an end cap mounted on the valve, during a process of generating the 3D model for the valve area of the gas container.

3. The gas supply system of claim 1, wherein the processor is configured to determine image similarities by comparing the generated 3D model with a plurality of reference images stored in the database, select a reference image with a highest image similarity to the generated 3D model, and match the selected reference image with the 3D model.

4. The gas supply system of claim 3, wherein the processor is configured to generate alignment information about 3D coordinates and an angle for the fastening device to be aligned in a state to be fastenable to the valve of the gas container, based on rotation angle and position information of the 3D model corresponding to the selected reference image.

5. The gas supply system of claim 4, wherein the processor is configured to generate the alignment information only when a rotation angle of the 3D model corresponding to the selected reference image is within a set angle range.

6. The gas supply system of claim 4, wherein the processor is configured to generate the alignment information only when the image similarity between the selected reference image and the generated 3D model is greater than or equal to a set reference value.

7. The gas supply system of claim 6, wherein the processor is configured to control a capturing angle of the 3D vision camera with respect to the valve area of the gas container to be adjusted when the image similarity between the selected reference image and the generated 3D model is less than the set reference value.

8. The gas supply system of claim 4, wherein the processor is configured to generate a movement path for aligning the fastening device optimally with respect to the gas container based on the generated alignment information, and control an operation of the mobile robot device so that a position of the fastening device is adjusted according to the generated movement path.

9. The gas supply system of claim 3, wherein the processor is configured to:
during a process of determining the image similarity between the generated 3D model and the reference image,
obtain pixels by dividing the generated 3D model two-dimensionally, and generate a pixel of a 3D image of a geometric structure by combining the obtained pixels, and
divide the generated 3D model and the reference image into a plurality of pixel areas, individually match the pixel areas, and determine the image similarity based on a matching state for each of the divided pixel areas.

10. The gas supply system of claim 1, further comprising:
a clamping device configured to support an outer circumferential surface of the gas container, and rotate the gas container about a rotation axis perpendicular to a ground,
wherein the processor is configured to rotate the gas container about the rotation axis through the clamping device, acquire an image of an end cap mounted on the valve of the gas container for each rotation angle of the gas container through the 3D vision camera when the gas container rotates about the rotation axis, and stop rotating the gas container in a state in which the acquired image of the end cap has an image similarity greater than or equal to a set reference value to a reference image of the end cap stored in the database.

11. The gas supply system of claim 1, wherein the fastening device is capable of detaching an end cap mounted on the valve while aligned in a first position with respect to the gas container, and fastenable to the valve while aligned in a second position with respect to the gas container.

12. The gas supply system of claim 1, wherein
the fastening device comprises a docking portion, and
the mobile robot device further comprises a docking module disposed at an end portion of the robot arm to be fastened to the docking portion.

13. The gas supply system of claim 12, wherein the docking module comprises a power motor configured to supply power to the docking portion.

14. The gas supply system of claim 1, wherein the 3D vision camera is disposed at an end portion of the robot arm.

15. The gas supply system of claim 1, further comprising:
a connecting module configured to movably connect the fastening device to the cabinet, wherein
the connecting module comprises one or more connecting joints configured to connect the cabinet and the fastening device, and each connecting joint is length-adjustable and rotatable through a joint.

16. A gas supply system comprising:
a cabinet in which a gas container is disposed;
a fastening device movable with respect to the gas container and capable of detaching an end cap from a valve of the gas container or fastenable to the valve while aligned with the valve;
a mobile robot device detachably connected to the fastening device and configured to move the fastening device;
a three-dimensional (3D) vision camera configured to collect an image; and
a processor configured to control an operation of the mobile robot device based on the image collected by the 3D vision camera,
wherein the mobile robot device comprises:
a body movable outside the cabinet; and
a robot arm installed on an upper portion of the body, the robot arm comprising a multi-joint arm, and
the processor is configured to generate a 3D model for the end cap mounted on the valve of the gas container through the 3D vision camera, match the generated 3D model of the end cap with any one reference image stored in a database, determine a position and angle state of the end cap mounted on the valve of the gas container based on the matched reference image, and operate the mobile robot device to align the fastening device in a state to be capable of detaching the end cap from the valve based on a result of the determining.

17. The gas supply system of claim 16, wherein the processor is configured to determine image similarities by comparing the generated 3D model of the end cap with a plurality of reference images stored in the database, select a reference image with a highest image similarity to the generated 3D model of the end cap, match the selected reference image with the generated 3D model of the end cap, and generate information about movement coordinates and a rotation angle for alignment of the fastening device based on rotation angle and position information of the 3D model corresponding to the matched reference image.

18. The gas supply system of claim 16, wherein the fastening device comprises:
an end cap detacher configured to detach an end cap mounted on the valve while aligned in a first position with respect to the gas container;
a valve connector configured to be fastened to the valve to receive a gas while aligned in a second position with respect to the gas container; and
a docking portion configured to receive power from an outside.

19. The gas supply system of claim 18, further comprising:
a docking module installed at an end portion of the robot arm, and connected to the docking portion to operate the fastening device,
wherein the docking module comprises:
a fastening portion to be fastened to the docking portion of the fastening device; and
a power motor configured to supply power to the fastening device through the docking portion.

20. A gas supply system comprising:
a clamping device configured to support a gas container, and rotate the gas container about a rotation axis perpendicular to a ground;
a three-dimensional (3D) vision camera configured to collect an image; and
a processor configured to control an operation of the clamping device,
wherein the processor is configured to:
operate to rotate the gas container about the rotation axis through the clamping device, collect an image of an end cap mounted on a valve of the gas container for each rotation angle of the gas container at a set point through the 3D vision camera, and select an end cap image having a highest similarity by comparing the end cap images for each rotation angle of the gas container with a reference image stored in a database, and
control the clamping device so that the rotation angle of the gas container about the rotation axis is aligned with a rotation angle corresponding to the selected end cap image.
